(19) United States
(12) Patent Application Publication
(10) Pub. No.: US 2004/0239571 A1
(43) Pub. Date: Dec. 2, 2004

(54) Slot-coupled radar antennae with radiative surfaces

(75) Inventors: Uwe Papziner, Oberriexingen (DE); Bernd Biehlman, Ludwigsburg (DE); Dirk Walz, Wemding (DE); Frank Kunzler, Kraichtal (DE)

Correspondence Address: Dreiss, Fuhlendorf, Steimle &, Becker Patentanwalte, Postfach 10 37 62, Stuttgart, D-70032, DE

(73) Assignee: Valeo Schalter und Sensoren GmbH, Bietigheim-Bissingen (DE)

(21) Appl. No.: 10/814,130

(22) Filed: Apr. 1, 2004

(30) Foreign Application Priority Data
Apr. 17, 2003 (DE) 103 18 815.0

(51) Int. Cl. H01Q 1/32

(52) U.S. Cl. 343/713; 343/700 MS

(57) ABSTRACT

The invention presents a radar antennae (10) for motor vehicle applications comprising at least one supply network (18) on a first side (20) of a high-frequency substrate (22), a metallic ground surface (24) on a second side (26) of the high-frequency substrate (22) opposite to the supply network (18), with and at least one radiative surface (28) which is excited by the supply network (18) via an associated aperture (30) in the metallic ground surface (24) and via a dielectric (32) disposed between the ground surface (24) and the radiative surface (28), to radiate electromagnetic waves, and with a housing (12). The radar antennae (10) is characterized in that the radiative surface (28) is firmly connected to the housing (12). The invention also presents a method for producing such radar sensors (10).

This application claims Paris Convention priority of DE 103 18 815.0 filed Apr. 17, 2003 the complete disclosure of which is hereby incorporated by reference.

### BACKGROUND OF THE INVENTION

The invention concerns a radar antennae for motor vehicle applications comprising at least one supply network on a first side of a high-frequency substrate, a metallic ground surface on a second side of the high-frequency substrate opposite to the supply network, and at least one radiative surface which is excited by the supply network, via an associated aperture in the metallic ground surface and via a dielectric disposed between the ground surface and the radiative surface, to radiate electromagnetic waves, and with a housing which accommodates the radar antennae.

The invention also concerns a method for producing a radar sensor having the above-mentioned features.

Such a radar sensor and such a production method are known per se. Radar sensors are generally used in motor vehicles to monitor the surroundings of a vehicle for applications such as parking assistance, dead angle monitoring, accident anticipation (pre-crash sensing), start/stop operation or driving with distance monitoring and/or control (cruise control support).

Towards this end, preferably slot-coupled patch antennaes are used for the broad-band pulse radar sensors which are conventionally used in this technical field. Such antennaes have radiative surfaces (patches) which are excited by an antennae supply network to radiate electromagnetic waves via an associated aperture in a metallic ground surface and via a dielectric disposed between the ground surface and the radiative surface. The aperture is generally an elongated slot.

As described above, the radiative element acts as a resonator which is excited by the supply network through capacitive coupling via the dielectric.

Group radiators can be produced from basic planar antennae elements through periodic arrangement of the basic antennae elements, whose dimensions and geometrical arrangement determine the radiation direction, i.e. the field distribution in front of the antennae. Suitable phase-controlled excitation of phase-coupled resonators of the periodically disposed basic antennae elements effects scanning in different spatial directions without changing the geometric orientation of the radar sensor (principle of phased array radar).

One advantage of the planar antennae structures compared to conventional antennaes lies in the fact that they can be produced with inexpensive and compact, light-weight construction and can be easily integrated with micro strip conducting switches over large frequency ranges (approximately 100 MHz to 100 GHz). These advantages are counteracted by the disadvantage of comparable small bandwidth, since the time duration delta_t of a signal and the frequency properties thereof, i.e. the bandwidth, are inversely proportional.

A broad-band signal is desired since the spatial resolution of reflecting objects, i.e. the minimum distance at which two separate objects can be recognized as being separate, improves with increasing bandwidth. To increase the bandwidth, the radar sensors are generally operated in a pulsed fashion, since the signal bandwidth increases with decreasing pulse width.

The small thickness of the metal of the radiative surfaces and the fact that the electrically conducting surfaces of the patches do not necessarily require excellent electrical conducting properties, permits many different production methods.

In the known radar sensor, the antennae surfaces are applied onto a dielectric foam which hardens to a solid foam before or after application of the antennae surfaces. The antennae surfaces are typically applied through gluing a foil carrying several radiative surfaces (patches). The dimensions of the solid foam determine the separation between the radiative surfaces and the apertures in the ground surface. A predetermined separation must thereby be kept with maximum precision, since the distance influences the radiation. The radiation strength at relatively small separations is low, whereas separations having a ratio between separation and radiated wavelength lambda of between 0.1 and 0.2 enhance the radiative effect.

The material used to support the antennae surface at a certain separation should have as small a dielectric constant as possible if broad-band radiation is desired. Since foams have a relatively small dielectric constant, they are used as carrier material for the conventional radar sensor. The pre-fabricated sensor plate with antennae surfaces is inserted into a protective plastic housing.

This radar sensor structure known per se having the foam as carrier for the antennae patches is quite unsuitable for use in the automobile industry since the foam material has only a short service life due to environmental influences and since high dimensional stability is required.

A further disadvantage is the fact that the shape and properties of the foam material change, i.e. age, due to permanent temperature changes in the course of the service life of a vehicle of several years. In the extreme case, aging can cause detachment of the radiative surfaces from the foam. The production of radar sensors using foam as a carrier is moreover rather unsuitable for mass production.

In view of the above, it is the underlying purpose of the invention to produce a radar sensor eliminating the above-mentioned disadvantages. The object also consists in providing a method for producing a radar sensor which eliminates the above-mentioned disadvantages.

### SUMMARY OF THE INVENTION

This object is achieved with a radar sensor of the above-mentioned type in that the radiation surface is rigidly connected to the housing. This object is achieved in correspondence with a method of the above-mentioned type in that the radiation surface is rigidly connected to the housing.

These features completely achieve the object of the invention. Direct, rigid mounting of the radiative surfaces to the housing of the radar sensor completely omits the use of foam as coupling medium and carrier for the radiative surfaces. Moreover, the direct, rigid mounting of the radiative surfaces to the sensor housing permits realization of the aperture-coupled antennae with an air gap as ideal coupling medium to increase the bandwidth. Air provides a maximum bandwidth due to its small dielectric constant, which is almost equal to one.

In addition to inexpensive production, this solution has the further advantage that manufacture of the radar sensor is considerably simplified due to the fact that no foam must be processed, and the antennae surfaces must not be applied onto the foam material. The problems resulting from use of foams as carrier material which possibly arise only after years of operation of a vehicle, can be completely eliminated. The invention permits utilization of an inexpensive, reliable and proven manufacturing technology for applying the metallic radiative surfaces onto a plastic housing which moreover resists environmental influences in vehicle applications in a reliable and durable fashion. This provides, in total, a simple method for inexpensive production of a radar sensor antennae for vehicle applications which is also suited for mass production.

In a preferred fashion, a reinforcing structure is disposed between the ground surface and the housing or the plane of the radiative surface whose thickness defines the separation between the ground surface and the radiative surface. This has the advantage of long-term stable separation between the radiative surface and ground surface such that the radiation characteristic of the antennae remains constant even over long time periods on the order of the service life of motor vehicles.

In a further preferred fashion, an air volume serving as dielectric is defined by a recess in the reinforcing structure, disposed between the radiative surface and the ground surface. Utilization of air as dielectric in the recess is advantageous in that the bandwidth of the antennae, which depends on the relative dielectric constant of the dielectric, is substantially maximized due to the value of air of nearly one.

It is also preferred to dispose the at least one radiative surface on a side of the housing facing the ground surface. Such an arrangement of the radiative surface inside the housing provides optimum protection of the radiative surface from environmental influences such as splashing water, which also favors the long-term stability of the radiation properties.

It is also preferred to dispose the at least one radiation surface on a side of the housing opposite to and facing away from the ground surface. This embodiment is advantageous in that the housing itself fills at least part of the separation between radiative surface and ground surface such that the radar sensor is flatter.

In a method for producing a radar sensor for motor vehicle applications, it is also preferred to produce the firm connection between the at least one radiative surface and the housing by pressing at least one pre-fabricated metallic radiation surface onto the housing using a hot-stamping process. Such a hot-stamping process can be realized with high positioning accuracy of the radiative surfaces and with little technical effort. The quality of the connection between housing and radiative surface is also excellent; the connection is durable and very strong. The hot-stamping technology is a very inexpensive, reliable production method which provides accurate positioning and permits mass production and which has proven to exhibit good results when the process parameters and the plastic material are properly selected, even in demanding environmental surroundings, i.e. in a motor vehicle.

In a preferred alternative, the firm connection between the at least one radiative surface and the housing is produced by gluing at least one pre-fabricated metallic radiative surface to the housing. Gluing processes require little technical control and are inexpensive.

A further preferred alternative is characterized in that the firm connection between the at least one radiative surface and the housing is produced through metallic coating of at least one part of the housing and subsequent removal of the coating except for a predetermined radiative surface through etching, or cutting out of the radiative surfaces using a laser. Such etching processes associated with photolithographic methods also produce high accuracy of arrangement of the radiative surfaces as well as high quality of connection. This is also the case when the patches are cut out with a laser.

Further advantages can be extracted from the description and the enclosed drawing.

Clearly, the features mentioned above and below not only can be used in the individually stated combination but also in other combinations or individually, without departing from the scope of the present invention.

The drawing shows embodiments of the invention which are explained in more detail in the following description.

### BRIEF DESCRIPTION OF THE DRAWING

FIG. 1 schematically shows an overall view of a radar sensor for motor vehicle applications;

FIG. 2 shows a schematic sectional view of the radar sensor according to FIG. 1 with an inner structure known from prior art;

FIG. 3 shows a schematic sectional view of a radar sensor of FIG. 1 with a first embodiment of the inventive structure;

FIG. 4 shows a schematic sectional view of a second embodiment of an inventive structure;

FIG. 5 shows a perspective view of part of a housing of a radar sensor;

FIG. 6 shows a perspective view of part of a reinforcing structure;

FIG. 7 shows a perspective view of part of a ground surface on a high-frequency substrate; and

FIG. 8 shows a hot-stamping step within the scope of the inventive method.

### DESCRIPTION OF THE PREFERRED EMBODIMENT

Reference numeral 10 in FIG. 1 designates the schematic overall view of a radar sensor with a housing 12 which is closed by a lid 14. The broken lines 15 show the orientation or arrangement of individual radiative surfaces within the housing 12. Reference numeral 16 designates a connecting element via which e.g. a supply voltage is fed to the radar sensor 10 and/or via which the radar sensor 10 transmits signals to control devices of a motor vehicle. The arrow designated with reference numeral 17 shows the direction of the longitudinal axis of the motor vehicle.

The orientation of the radar sensor 10 relative to the direction 17 of the longitudinal axis shows a typical installation position of the radar sensor 10 in a motor vehicle application. The invention is, of course, not limited to such an orientation of the radar sensor 10 relative to the direction 17 of the longitudinal axis of the motor vehicle.

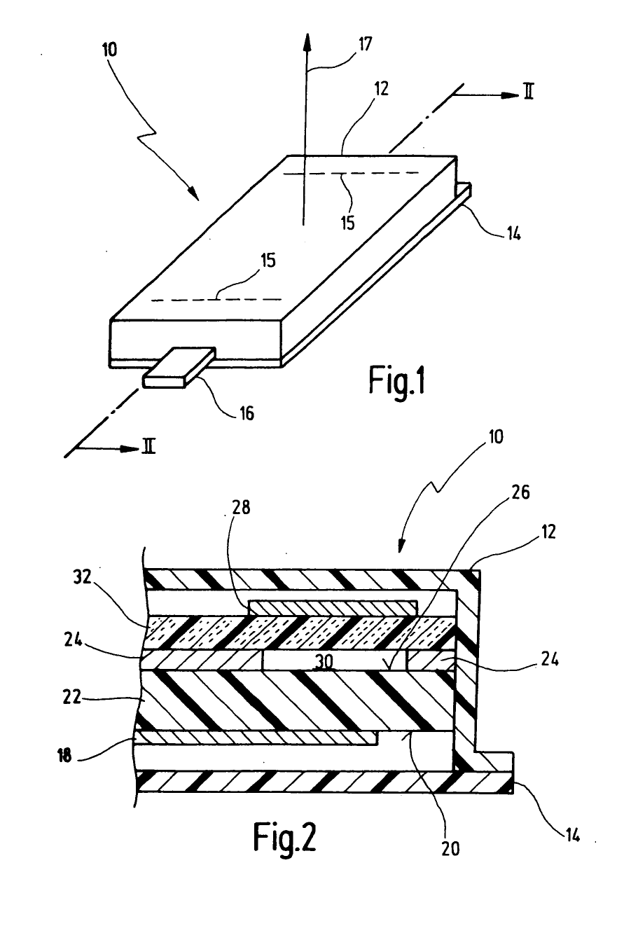

FIG. 2 shows a partial section of the radar sensor 10 of FIG. 1, wherein the inner structure of the radar sensor 10 shown in FIG. 2 is known per se. Reference numeral 18 in FIG. 2 designates a supply network which is connected to the connecting element 16 of FIG. 1 and is disposed on the first side 20 of a high-frequency substrate 22. A metallic ground surface 24 is disposed on the second side 26 of the high-frequency substrate 22. The radar sensor 10 has at least one radiative surface 28 (patch) which is excited by the supply network 18 via an aperture 30 in the metallic ground surface 24 and via a dielectric 32 disposed between the ground surface 24 and the radiative surface 20, to radiate electromagnetic waves. The radiative surface 28 of this conventional radar sensor is disposed on the dielectric 32 and is therefore supported and carried by the dielectric 32. The dielectric 32 is generally solidified foam. The use of solidified foam as dielectric 32 has the above-mentioned disadvantages.

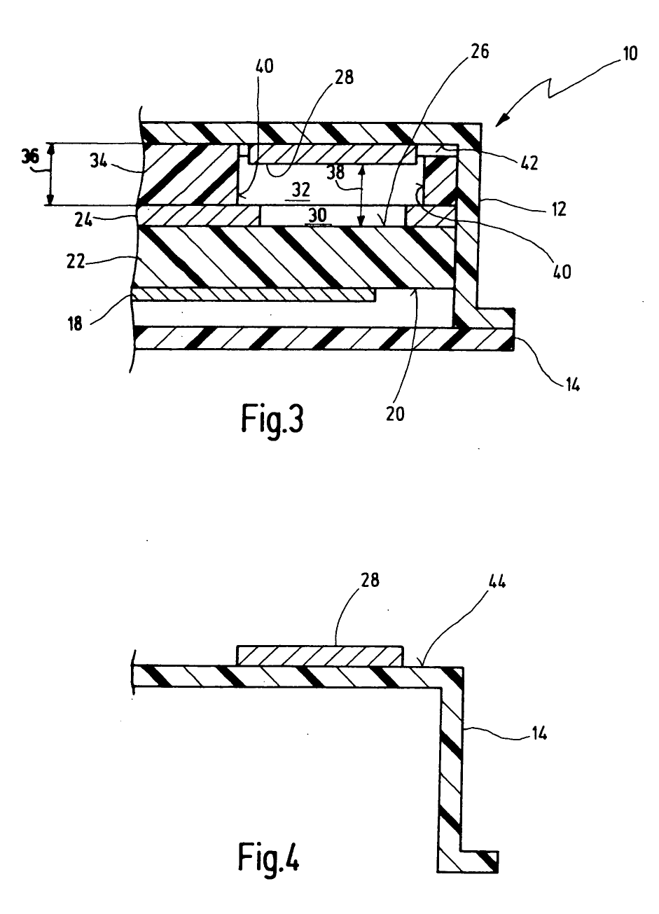

To eliminate these disadvantages, the radiative surface 28 of the instant invention is not supported by a foam 32 as dielectric but is rather firmly connected to the housing 12. The partial section of FIG. 3 shows a first embodiment of an inventive radar sensor 10. The radar sensor 10 of FIG. 3 also has a supply network 18 which is disposed on a first side 20 of the high-frequency substrate 22 with an opposite metallic ground surface 24 which is disposed on a second side of the high-frequency substrate 22. The radiative surface 28 is also excited via an associated aperture 30 in the metallic ground surface 24 to radiate electromagnetic waves.

In contrast to the conventional radar sensor 10 of FIG. 2, the radar sensor 10 of FIG. 3 has no foam as dielectric 32 which would carry the radiation surface 28. The radiation surface of the embodiment of FIG. 3 is instead firmly connected to the inner side of the housing 12 and disposed opposite to the aperture 30 of the metallic ground surface 24.

A reinforcing structure 34 is disposed between the ground surface 24 and the housing 12 whose thickness 36 defines the separation 38 between the ground surface 24 and the radiative surface 28. An opening 40 in the reinforcing structure 34 defines an air volume 32 between the radiative surface 28 and the ground surface 24. The air volume 32 repesents the dielectric between the ground surface 24 and the radiation surface 28 in the embodiment of FIG. 3.

FIG. 4 shows a second embodiment of a housing 14 for a radar sensor 10. In FIG. 4, the radiative surface 28 is disposed on a side 44 of the housing 14 facing away from the ground surface 24. In other words, the radiative surface 28 is disposed on the outside of the housing 14 in the embodiment of FIG. 4.

In contrast thereto, the radiative surface 28 of the embodiment of FIG. 3 is disposed on a side 42 of the housing 12 facing the ground surface 24, i.e. inside the housing 12.

FIG. 5 shows a perspective view of part of the housing 12 of the embodiment of FIG. 4 with radiative surfaces 28 mounted on the outside.

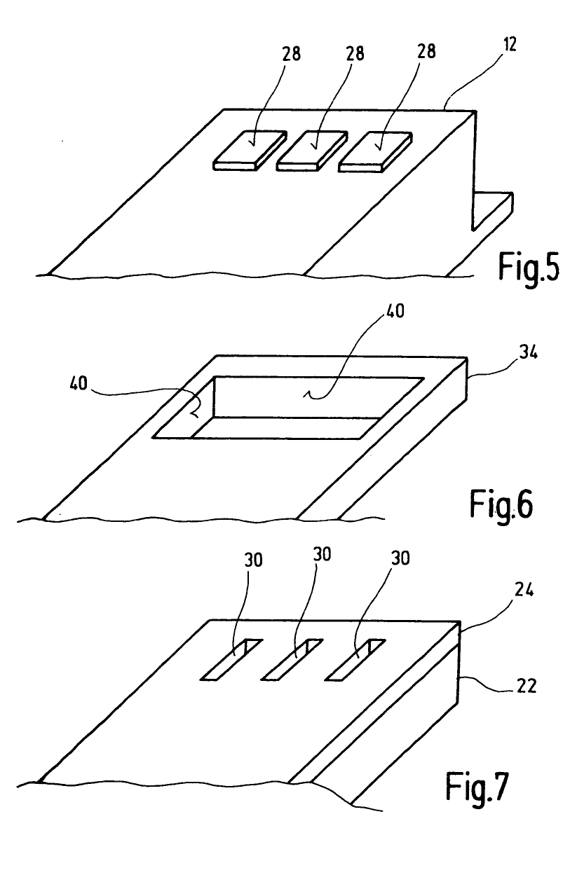

FIG. 6 shows a corresponding perspective view of the reinforcing structure 34 with opening 40 and FIG. 7 shows a corresponding perspective view of the ground surface 24 with slotted apertures 30 on a high-frequency substrate 22.

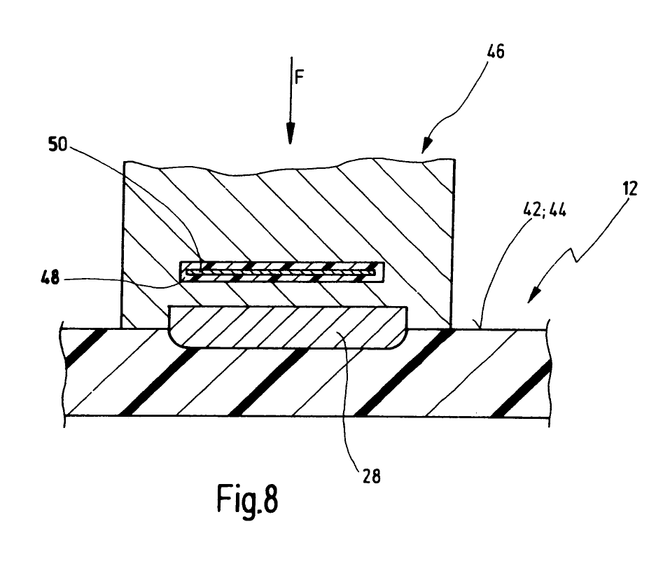

In FIG. 8, reference numeral 46 illustrates a hot-stamping stamp which is provided with a heater 50 embedded in an electric insulation 48. FIG. 8 thereby illustrates an embodiment of a method for producing the radar sensor 10. The hot-stamping stamp 46 is heated by an electric heater 48 embedded in an electrically insulating body 48. The hot-stamping stamp 46 maintains thermal contact with a radiative surface 28 such that the heat of the hot-stamping stamp 46 is transmitted to the radiative surface 28. The metal squares of the radiative surfaces of the patches are preferably previously punched out from a metal foil by means of the hot-stamping stamp. The hot-stamping stamp 46 is pressed downwards in FIG. 8 onto the structure of the housing 12, shown in sections, with a force F such that the heated radiative surface 28 is hot-stamped into the housing structure 12 providing a firm connection with the material of the housing structure 12.

The metal foil from which the patches are stamped out, may be coated with a support which becomes sticky at increased temperatures such that it is glued to the plastic housing via the stamp.

Alternatively, the patches can be heated until they melt the plastic housing surface during stamping.

As already shown in FIGS. 3 and 4, the radiative surface 28 can be stamped into an inner side 42 of the housing 12 facing the ground surface 24 and also into an outer side 44 of the housing structure 12 facing away from the ground surface 24.

In an alternative variant, the metal layer is applied using a wet-chemical process. The patches are removed from the metal layer through laser or etching.

We claim:

1. A radar antennae for motor vehicle applications, the antennae comprising:
a housing;
a radio frequency substrate disposed in said housing;
a supply network disposed on a first side of said radio frequency substrate;
a metallic ground surface disposed on a second side of said radio frequency substrate opposite said supply network, said metallic ground surface having an aperture;
a radiative surface firmly connected to said housing, said radiative surface excited by said supply network, via said aperture in said metallic ground surface, to radiate electromagnetic waves; and
a dielectric disposed between said ground surface and said radiative surface.

2. The radar antennae of claim 1, wherein said dielectric is air.

3. The radar antennae of claim 1, further comprising a reinforcing structured disposed between said ground surface and said housing, said reinforcing structure having a thickness defining a separation between said ground surface and said radiative surface.

4. The radar antennae of claim 3, wherein said reinforcing structure is disposed between said ground surface and a plane of said radiative surface.

5. The radar antennae of claim 3, wherein said dielectric is air and an air volume which serves as said dielectric is defined by an opening in said reinforcing structure, said opening disposed between said radiative surface and said ground surface.

6. The radar antennae of claim 1, wherein said radiative surface is disposed on a side of said housing facing said ground surface.

7. The radar antennae of claim 1, wherein said radiative surface is disposed on a side of said housing facing away from said ground surface.

8. A method for producing a radar antennae for motor vehicle applications, the method comprising the steps of:
a) disposing a radio frequency substrate in a housing;
b) disposing a supply network on a first side of said radio frequency substrate;
c) disposing a metallic ground surface at a second side of said radio frequency substrate opposite said supply network, said metallic ground surface having an aperture;
d) firmly connecting a radiative surface to said housing, said radiative surface excited by said supply network, via said aperture in said metallic ground surface, to radiate electromagnetic waves; and
e) disposing a dielectric between said ground surface and said radiative surface.

9. The method of claim 8, wherein said firm connection between said radiative surface and said housing is generated by pressing at least one pre-fabricated metallic radiation surface onto said housing using a hot-stamping process.

10. The method of claim 8, wherein said firm connection between said radiative surface and said housing is generated by gluing at least one pre-fabricated metallic radiative surface to said housing.

11. The method of claim 8, wherein said firm connection between said radiative surface and said housing is generated by metallically coating at least part of said housing, wherein portions of said coating are subsequently removed through etching to define said radiative surface.

12. The method of claim 8, wherein said firm connection between said radiative surface and said housing is generated by metallically coating at least part of said housing, said radiative surfaces being subsequently cut out of said coating using a laser.
